(19) United States
(12) Patent Application Publication
(10) Pub. No.: US 2014/0065518 A1
(43) Pub. Date: Mar. 6, 2014

(54) PROCESS FOR PRODUCING RECHARGEABLE ELECTROCHEMICAL METAL-OXYGEN CELLS

(71) Applicant: BASF SE, Ludwigshafen (DE)

(72) Inventors: Alexander PANCHENKO, Ludwigshafen (DE); Sigmar Braeuninger, Hemsbach (DE); Arnd Garsuch, Ludwigshafen (DE); Ruediger Schmidt, Ludwigshafen (DE)

(73) Assignee: BASF SE, Ludwigshafen (DE)

(21) Appl. No.: 14/011,914

(22) Filed: Aug. 28, 2013

Related U.S. Application Data
(60) Provisional application No. 61/697,327, filed on Sep. 6, 2012.

(51) Int. Cl. H01M 12/08

(52) U.S. Cl. CPC H01M 12/08
USPC 429/535; 427/115

(57) ABSTRACT

The invention relates to a process for producing a rechargeable electrochemical metal-oxygen cell, comprising at least one positive electrode, at least one negative metal-comprising electrode and at least one separator having two sides for separating the positive and negative electrodes, wherein, in one of the process steps, at least one side of the separator is coated with at least one material for forming one of the two electrodes (hereinafter referred to as electrode material) or at least one side of at least one of the two electrodes is coated with at least one material for forming the separator (hereinafter referred to as separator material) to form a separator-electrode assembly.

The invention relates to a process for producing a rechargeable electrochemical metal-oxygen cell, comprising at least one positive electrode, at least one negative metal-comprising electrode and at least one separator having two sides for separating the positive and negative electrodes, wherein, in one of the process steps, at least one side of the separator is coated with at least one material for forming one of the two electrodes (hereinafter referred to as electrode material) or at least one side of at least one of the two electrodes is coated with at least one material for forming the separator (hereinafter referred to as separator material) to form a separator-electrode assembly.

Metal-air batteries are already known. These comprise, as essential constituents, a negative electrode composed of, for example, aluminum, lithium, magnesium, cadmium, mercury, lead, iron or preferably zinc and a positive electrode which preferably consists of an electronically conductive support material composed of finely divided carbon to which a catalyst for oxygen reduction is applied. Here, negative electrode and positive electrode are separated by a separator which can be in the form of a membrane. In a widespread embodiment, metal, for example zinc, is oxidized by means of atmospheric oxygen in an alkaline electrolyte to form an oxide or hydroxide. The energy liberated here is utilized electrochemically. Commercially available metal-air batteries are at present not rechargeable. However, intensive research is being carried out on rechargeable electrochemical metal-oxygen cells in which the metal ions formed during discharge are reduced back to the metal by application of an electric potential and oxygen is liberated by oxidation of the oxides or hydroxides formed during discharge. Rechargeable electrochemical metal-oxygen cells can, depending on the metal used, be operated both with aqueous acidic electrolytes (WO2012/012558) or basic or virtually water-free electrolytes (WO2011/161595).

To produce the electrochemical cells, negative electrode, membrane and positive electrode are generally produced separately and then pressed onto one another and introduced into an enveloping container.

Metal-oxygen cells usually comprise gas diffusion electrodes. Forming gas diffusion electrodes from an electronically conductive, porous support material, for example finely divided carbon, which is coated with catalyst for catalyzing the reduction of oxygen and oxygen evolution is known. It is also known that the gas diffusion electrode can be provided with pores which during operation are covered with an electrolyte film which represents an enlarged reaction area for the catalyzed reaction in the three-phase gas/liquid/solid system. The size of the pores and the hydrophobicity or hydrophilicity of the materials used are of great importance for optimal operation in order to prevent, for example, the electrolyte from filling the pores completely since this can, for example, hinder the passage of reaction gases such as oxygen.

WO 2007/065899 A1 has disclosed bifunctional air electrodes for secondary metal-air batteries in which the active layer of the electrode comprises an oxygen reduction catalyst and La₂O₃, Ag₂O and spinels as bifunctional catalyst. WO 2005/004260 A1 discloses a process for producing a gas diffusion electrode suitable for metal-air batteries, in which an active layer and a gas diffusion layer are combined to produce the gas diffusion electrode.

It is known from US 2002/064593 A1 that a membrane-electrode assembly for fuel cells can be produced by providing a membrane with a catalyst firstly on the one side and then on the other side, with one side in each case being supported by a substrate. U.S. Pat. No. 5,861,222 A discloses gas diffusion electrodes for fuel cells, which electrodes consist essentially of a proton-conducting membrane coated with a proton-conducting polymer having a defined porosity. US 2003/118890 A1 discloses membrane-electrode assemblies for fuel cells, in which the catalyst layer of the positive electrode and/or the negative electrode has at least two sublayers of which at least one is located directly on the membrane surface. US 2004/124091 A1 discloses a process for coating electrolyte membranes for fuel cells, in which the front side of the membrane is firstly coated with a catalyst while the rear side rests on a supporting film, and the rear side is subsequently coated. US 2004/023105 A1 discloses a process for applying a catalyst ink to a substrate for fuel cells at controlled humidity and temperature. US 2007/077350 A1 discloses the production of electrolyte membranes for fuel cells, where the membrane is supported by a film during a coating step. CA 2,511,920 A1 discloses gas diffusion layers for fuel cells, which layers consist of a porous substrate and catalyst particles distributed uniformly thereon.

Known metal-air batteries comprise, as significant constituents, a negative electrode composed of, for example, aluminum, lithium, magnesium, iron or preferably zinc and a positive electrode which preferably comprises a conductive support material composed of finely divided carbon and on which catalyst for oxygen reduction and oxygen evolution is applied on the electrolyte side. Here, negative electrode and positive electrode are separated by a membrane. To produce the batteries, negative electrode, membrane and positive electrode are generally produced separately and then pressed on top of one another and introduced into an enveloping container.

A disadvantage of the known production processes is that the joining of the individual constituents is complicated and susceptible to malfunction.

It was therefore an object of the present invention to provide an improved process for producing rechargeable electrochemical metal-oxygen cells for metal-air batteries.

The invention provides a process for producing a rechargeable electrochemical metal-oxygen cell, comprising at least one positive electrode, at least one negative metal-comprising electrode and at least one separator having two sides for separating the positive and negative electrodes, wherein, in one of the process steps, at least one side of the separator is coated with at least one material for forming one of the two electrodes (hereinafter referred to as electrode material) or at least one side of at least one of the two electrodes is coated with at least one material for forming the separator (hereinafter referred to as separator material) to form a separator-electrode assembly.

The rechargeable electrochemical metal-oxygen cell which can be produced by the process of the invention comprises at least one positive electrode, at least one negative metal-comprising electrode and at least one separator having two sides for separating the positive and negative electrodes.

A gas diffusion electrode known to those skilled in the art, as is known, for example from the prior art referred to above, is preferably used as positive electrode for rechargeable electrochemical metal-oxygen cells. A gas diffusion electrode consists essentially of a support material, for example composed of finely divided carbon, and catalysts for the reduction of oxygen during discharge and optionally for the evolution of oxygen during charging. Suitable support materials are carbon and in particular tungsten carbide.

Suitable catalysts for the gas diffusion electrode are, in particular, mixed oxides, for example cobalt oxides, nickel oxides, iron oxides, chromium oxides, tungsten oxides, and noble metals, in particular silver. In a preferred embodiment, a catalyst combination of a catalyst which catalyzes the reduction of oxygen and a bifunctional catalyst as described in WO 2007/065899 A1, page 7, line 14 to page 8, line 27, is used. A preferred catalyst which catalyzes both oxygen oxidation and reduction is La₂O₃. Preferred catalysts for the reduction of oxygen are MnO₂, KMnO₄, MnSO₄, SnO₂, Fe₂O₃, Co₃O₄, Co, CoO, Fe, Pt, Pd, Ag₂O, Ag, spinels or perovskites.

In a preferred variant of the process of the invention, a gas diffusion electrode comprising carbon and at least one catalyst, preferably based on a metal mixed oxide or a noble metal, is used as positive electrode.

Electrodes comprising conventional metals, preferably iron, aluminum, magnesium, lithium or in particular zinc are suitable as negative metal-comprising electrode for rechargeable electrochemical metal-oxygen cells. The metal can be present as a solid plate, as a sintered, porous electrode, as metal powder or granular material, optionally sintered. In a preferred embodiment, the metal, in particular zinc, is present as powder having a particle size of preferably from 2 to 500 μm. In a further preferred embodiment, the powder is admixed with a binder to improve the dimensional stability. Suitable binders can be organic or inorganic in nature, with preference being given to, in particular, polytetrafluoroethylene (PTFE) and polyvinylidene fluoride.

In a preferred embodiment, the metal powder, in particular the zinc powder, is used in the form of a paste with an organic binder, in particular with polytetrafluoroethylene (PTFE) and/or polyvinylidene fluoride as binder.

As separator having two sides for rechargeable electrochemical metal-oxygen cells, preference is given to using a sheet-like shaped body composed of an acid- or alkali-resistant, inert material. Examples of a sheet-like shaped body are, for example, films, membranes, nonwovens or woven fabrics.

For the purposes of the present invention, the expression “sheet-like” means that the separator described, a three-dimensional body, is smaller in one of its three dimensions (extensions) in space, namely the layer thickness, than in the two other dimensions, the length and the width. The layer thickness of the separator is usually smaller than the second-largest dimension by a factor of at least 5, preferably by a factor of at least 10, particularly preferably by a factor of at least 20.

In a preferred embodiment, polyolefins are used as material for the separator. Preferred polyolefins are polyethylene and polypropylene. In addition, other acid- or alkali-resistant polymers known to those skilled in the art and inorganic compounds are suitable as materials for separators. The separator can be configured either as a porous sheet-like shaped body, for example as nonwoven or perforated film, so as to be permeable to the electrolyte or be configured as a sheet-like shaped body which is impermeable to liquids but conducts ions, for example a membrane composed of an ion-conducting organic or inorganic material.

In a preferred embodiment, the separator has a porosity of from 30 to 80%, in particular from 40 to 70%. For the purposes of the present invention, the porosity is the ratio of hollow space volume to total volume.

In a preferred variant of the process of the invention porous materials based on polyolefins, polytetrafluoroethylene or glass fibers, in particular polytetrafluoroethylene or glass fibers, are used as separator or membranes based on ion-conducting materials are used as separator.

In a preferred variant of the process of the invention, the separator has a porosity of from 30 to 80%.

In one of the process steps of the process of the invention, at least one side of the separator is coated with at least one material for forming one of the two electrodes (hereinafter referred to as electrode material) or at least one side of at least one of the two electrodes is coated with at least one material for forming the separator (hereinafter referred to as separator material) to form a separator-electrode assembly.

Just as the separator having two sides is preferably a sheet-like shaped body, the electrode is, in the first variant, also configured as a sheet-like shaped body, i.e. as layer. If, according to the second variant, a material for forming a separator is applied to one of the two electrodes, the electrode is in this case preferably a sheet-like shaped body, so that in this case, too, the separator formed is once again present in a sheet-like form, i.e. as layer, at the end of the process.

The coating can preferably be carried out by application of a paste or dispersion of the electrode material or by spraying with a solution of the separator material. In this way, a firm bond between the applied material and the respective application site, which owing to its strength is mechanically very stable, is achieved. Joining of the individual parts of the metal-air battery is considerably simplified and less susceptible to problems.

In the first variant of the process of the invention, it is possible for, as electrode material, the material for producing a negative metal-comprising electrode (hereinafter referred to as negative electrode material) or the material for producing a positive electrode (hereinafter referred as positive electrode material) to be applied to one side of the separator, forming a separator-electrode assembly.

In a preferred embodiment of the process of the invention, the material for forming the negative metal-comprising electrode is used as electrode material for coating one side of the separator.

In a likewise preferred embodiment of the process of the invention, the material for forming the positive electrode is used as electrode material for coating one side of the separator.

In the first variant of the process of the invention it is likewise possible for the two sides of the separator to be coated with different electrode materials, namely one for forming a positive electrode and one for forming a negative metal-comprising electrode, with the order of the two coating steps being immaterial.

In a further preferred embodiment of the process of the invention, the separator is firstly coated on one side with the material for forming the positive electrode and subsequently on the other side with the material for forming the negative metal-comprising electrode, or the separator is firstly coated on one side with the material for forming the negative metal-comprising electrode and subsequently on the other side with the material for forming the positive electrode.

In a further preferred embodiment, the negative electrode material and the positive electrode material are firstly each applied to a separator. The two differently coated separators are subsequently laminated onto one another.

The rechargeable electrochemical metal-oxygen cells which can be produced by the process of the invention preferably have the following structures in terms of electrodes and separator:
1. negative electrode applied to separator/separator/positive electrode
2. positive electrode applied to separator/separator/negative electrode
3. negative electrode applied to separator/separator/positive electrode applied to separator.

Of course, a plurality of such arrangements of rechargeable electrochemical metal-oxygen cells can be arranged in series or in parallel in a metal-air battery built up therefrom.

The electrode materials for coating the separator, viz, the positive electrode material and the negative electrode material, which in the first variant of the process of the invention are each used for coating the separator, are preferably a paste or dispersion. These pastes and dispersions comprise the respective active material or materials, for example metals for the negative electrode or for example catalysts for the positive electrode, and also further auxiliaries such as binders which remain in the finished electrode and liquids which are, however, generally very largely removed from the electrode layer later.

In the case of the negative electrode material, this preferably comprises iron, aluminum, magnesium, lithium or zinc, in particular zinc. In the negative electrode material, the metal, in particular zinc, is present as powder having a particle size of preferably from 2 to 500 μm. In a further preferred embodiment, the powder is admixed with a binder in order to improve the dimensional stability. Suitable binders can be organic or inorganic, with preference being given to, in particular, polytetrafluoroethylene (PTFE) or polyvinylidene fluoride.

In a preferred embodiment, the metal powder, in particular the zinc powder, is used in the form of a paste with an organic binder, in particular with polytetrafluoroethylene (PTFE) and/or polyvinylidene fluoride as binder, as negative electrode material.

In a preferred embodiment of the process of the invention, the material for forming the negative metal-comprising electrode comprises zinc, aluminum, magnesium or lithium, in particular zinc, as metal.

In a further preferred embodiment of the process of the invention, the material for forming the negative metal-comprising electrode is present in the form of a paste comprising zinc, aluminum, magnesium or lithium, in particular zinc, in the form of a powder, in particular a powder having a particle size of from 100 to 200 μm, together with at least one binder, in particular polytetrafluoroethylene (PTFE) or polyvinylidene fluoride. The material for forming the negative metal-comprising electrode is particularly preferably a paste comprising zinc in the form of a powder having a particle size of from 100 to 200 μm together with the binder polytetrafluoroethylene (PTFE) or polyvinylidene fluoride.

The process for producing a rechargeable electrochemical metal-oxygen cell comprises further process steps in addition to formation of a separator-electrode assembly.

In a preferred embodiment, the production of the rechargeable electrochemical metal-oxygen cell comprises the following steps:
1. application of the separator to a carrier film,
2. application of an electrode paste to the side of the separator facing away from the carrier film,
3. optionally coating/conditioning by drying,
4. removal of the carrier film and application of a counterelectrode by means of an electrode paste to the other side of the separator,
5. optionally assembly together with further elements and placement in an enveloping container.

In a further preferred embodiment, production comprises the following steps:
1. application of the separator to a carrier film,
2. application of an electrode paste to the side of the separator facing away from the carrier film,
3. optionally coating/conditioning by drying,
4. removal of the carrier film and
5. assembly together with the counterelectrode and optionally further elements and placement in an enveloping container.

In a further preferred embodiment of the process of the invention, production comprises the following steps:
1. application of the separator to a carrier film,
2. application of an electrode material in the form of a paste to the side of the separator facing away from the carrier film,
3. optionally coating/conditioning by drying,
4. removal of the carrier film,
5. application of a further electrode material in the form of a paste for forming the second electrode (hereinafter referred to as counterelectrode) or joining to a separately produced counterelectrode, and
6. placement of the separator-electrode assembly obtained, optionally together with further elements, in a container which is optionally filled with electrolyte or can be filled with electrolyte.

The carrier film to which the separator is applied serves to stabilize the generally very thin and mechanically sensitive separator during the treatment steps 2 and 3. Suitable carrier films which can be easily separated from the applied separator and comprise, for example, an organic polymer, a metal or a paper-plastic laminate can be determined in a few tests.

For the purposes of the invention, the term counterelectrode refers in each case to the second electrode to be separated from the first electrode by the separator. The electrode/counterelectrode pair is accordingly the positive electrode/negative metal-comprising electrode pair.

Methods of coating a surface with a composition such as a solution, a dispersion or a paste are known in principle to those skilled in the art.

In a preferred embodiment of the present invention, the electrode material is applied in the form of a paste by means of screen printing, spraying or doctor blade coating in the process of the invention.

The separator in the rechargeable electrochemical metal-oxygen cells which can be obtained by the process of the invention can be used as finished product or be produced only during production of the separator-electrode assembly. Production of the separator can be carried out immediately before the first coating step using an electrode material according to the first variant or by coating of an electrode with a separator material according to the second variant to form a separator-electrode assembly. If a separator is to be produced before the first coating step using an electrode material, it is possible, for example, for a separator material to be applied to a carrier film from which the finished separator can easily be removed again later.

The separator material which is capable of forming a separator is preferably a polymer dissolved in a solvent or a polymerizable material.

In a preferred embodiment of the present invention, a polymer dissolved in a solvent or a polymerizable material is used as separator material in the process of the invention. Methods of producing a desired porosity of a separator produced from such a separator material are known to those skilled in the art. For example, a desired porosity can be achieved by adding a particular amount of one or more pore formers during the film-forming process, i.e. during formation of a layer, with the pore former being removed again after formation of the layer to form a pore. Pore formers can, for example, be removed by means of a thermal treatment or by treatment with a suitable solvent.

In the second variant for forming a separator-electrode assembly by the process of the invention, at least one side of at least one of the two electrodes is coated with at least one material for forming the separator (hereinafter referred to as separator material) to form a separator-electrode assembly.

In a further preferred embodiment of the present invention, a polymer dissolved in a solvent or a polymerizable material is applied to at least one electrode to form the separator in the process of the invention.

For this purpose, the polymer dissolved in a solvent can be, for example, sprayed onto at least one of the electrodes. Preference is given to using solvents in which the polymer of the separator dissolves particularly well. Such solvents are, for example, known from the “Polymer Handbook” by J. Brandrup and E. H. Immergut, 3rd edition, chapter VII, pages 379 to 402. Alkanes, in particular hexane, p-xylene, paraffin oil, squalane, mineral oil, paraffin wax and cyclooctane are particularly suitable. A particularly preferred solvent is dimethylacetamide (DMAc).

After the dissolved polymer has been sprayed on, the solvent is removed and the separator is thus formed. The separator can, in this embodiment, be produced on
1.) the positive electrode,
2.) the negative electrode or
3.) the positive electrode and the negative electrode by spraying-on of an appropriate polymer solution.

The layer sprayed on preferably has a layer thickness of from 10 to 500 μm, in particular from 50 to 200 μm, after removal of the solvent and curing.

Polymerizable materials are, for example, monomers which can be polymerized thermally or photochemically after addition of suitable initiators or two-component systems which on being combined form a polymer, for example epoxy resins based on a binder component and a hardener component. Polymerizable materials are known to a person skilled in the field of paints and varnishes and coating systems.

In a preferred embodiment for forming the separator, one component of a two-component system is applied to an electrode and the second component of the two-component system is applied to the counterelectrode. When the coated sides of electrode and counterelectrode are brought together, i.e. when the coated positive and negative electrodes are brought together, the separator layer is formed by a polymerization reaction.

In a preferred embodiment of the present invention, the application of a polymer dissolved in a solvent or a polymerizable material as separator material to the negative electrode in the process of the invention results in the negative electrode being enclosed on all sides by the separator.

In a further preferred embodiment of the present invention, an ion-conducting organic material, preferably one based on polymer-bonded quaternary ammonium salts or acidic ion exchangers, for example sulfonated tetrafluoroethylene polymer, also known commercially by the trade name Nafion®, is used as separator material, in particular for forming a membrane, in the process of the invention.

In a further variant of the process of the invention, a spinnable formulation of a polymer dissolved in a solvent is spun to form the separator.

In a particularly preferred process for producing rechargeable electrochemical metal-oxygen cells, coating of at least one side of an electrode with the separator material is effected by production of a spinnable formulation comprising at least one polymer in one or more solvents and optionally additives, spinning of the formulation by means of electrospinning or rotor spinning to form sheet-like fiber structures and application to at least one side of at least one electrode. The spinning process results in formation of sheet-like fiber structures which preferably have fibers having a diameter of from 50 nm to 3000 nm. These sheet-like fiber structures are preferably applied directly during spinning. After application, the sheet-like fiber structures are preferably dried to remove solvent residues. If necessary, the sheet-like fiber structures can be heated, preferably to a temperature above the melting point or glass transition temperature of the respective polymer.

The suitable spinning solution comprises at least one hydrophobic polymer in at least one solvent. The hydrophobicity of the polymer is determined by the size of the contact angle between water and the polymer. For the purposes of the present invention, a hydrophobic polymer is a polymer for which the contact angle is at least 90°. It is in principle possible to use all hydrophobic homopolymers, copolymers and blends known to those skilled in the art, with particular preference being given to materials comprising at least one of the following monomers: vinyl fluoride, vinylidene fluoride, styrene, alpha-methylstyrene; butadiene, isobutene, isoprene, ethylene, propylene, terephthalic acid. Further suitable polymers are vinyl esters or acrylic esters or methacrylic esters having a hydrocarbon side chain having 4-20 carbon atoms (hexanoates, octanoates, etc.) and acrylic esters or methacrylic esters having fluorinated side chains comprising 2-9 fluorine atoms. Furthermore, polysulfones, polyether sulfones, polyphenylene sulfones, polybenzimidazoles are suitable.

It is possible to use all polar and nonpolar solvents and mixtures thereof which are known to those skilled in the art. Examples which may be mentioned are toluene, chloroform, dichloromethane, DMF, THF, DMAc, acetone, HFIP.

The sheet-like fiber structures obtained in this way can be treated at above the melting point or glass transition temperature of the hydrophobic polymer in order to produce coalescence of the fibers at the crossing points and obtain a stable fiber network.

In a further embodiment of the present invention, it is possible to utilize a water-based formulation for producing the sheet-like fiber structure. Such a formulation comprises a hydrophobic, essentially water-insoluble polymer in the form of a colloidal dispersion. This technology is disclosed in the patent application WO2006089522.

In principle, it is possible to produce the colloidal polymer dispersions used according to the invention by all methods known for this purpose to those skilled in the art. The colloidal dispersions are preferably produced by emulsion polymerization of suitable monomers, giving the corresponding lattices. As colloidal polymer dispersions, it is also possible to use, for example, secondary dispersions. These are produced from previously prepared polymers by dispersion in an aqueous medium. In this way, it is possible to produce, for example, dispersions of polyolefins such as polyethylene or polyesters.

Suitable homopolymers, copolymers and blends are those which comprise at least one of the following monomers: tetrafluoroethylene, vinyl fluoride, vinylidene fluoride, tetrafluoroethylene, styrene, alpha-methylstyrene; butadiene, isobutene, isoprene, ethylene, propylene, terephthalic acid. Further suitable polymers are vinyl esters or acrylic esters or methacrylic esters having a hydrocarbon side chain having 4-20 carbon atoms (hexanoates, octanoates, etc.) and acrylic esters or methacrylic esters having fluorinated side chains comprising 2-9 fluorine atoms. Furthermore, polysulfones, polyether sulfones, polyphenylene sulfones, polybenzimidazoles are suitable.

Suitable homopolymers and copolymers of a-olefins are, for example, polyethylene, polypropylene, poly(ethylene/propylene) (EPDM) and olefin-vinyl acetate copolymers, for example ethylene-vinyl acetate copolymers, and olefin-acrylate copolymers for example ethylene-acrylate copolymers.

Suitable homopolymers and copolymers of vinyl halides are, for example, polytetrafluoroethylene, polyvinylidene fluoride, polyvinyl chloride, polytrichloroethylene, polytrifluoroethylene and/or polyvinyl fluoride.

Particularly good results are obtained in the process of the invention when using colloidal polymer dispersions in which the weight average particle diameter of the at least one essentially water-insoluble polymer is generally from 1 nm to 2.5 μm, preferably from 10 nm to 1.2 μm, particularly preferably from 15 nm to 1 μm. The weight average particle diameter of latex particles which are produced by emulsion polymerization and can, in a preferred embodiment, be used in the process of the invention is generally from 30 nm to 2.5 μm, preferably from 50 nm to 1.2 μm (determined by the method of W. Scholtan and H. Lange in Kolloid Z. and Polymere 250 (1972), pp. 782 to 796, by means of an ultracentrifuge). Very particular preference is given to colloidal polymer suspensions, in particular lattices, in which the polymer particles have a weight average particle diameter of from 20 nm to 500 nm, in particular from 30 nm to 250 nm.

The colloidal dispersion which is preferably used according to the invention can comprise particles having a monomodal particle size distribution of the polymer particles or a bimodal or polymodal particle size distribution. The terms monomodal, bimodal and polymodal particle size distribution are known to those skilled in the art.

If the latex to be used according to the invention is based on two or more monomers, the latex particles can be arranged in any way known to those skilled in the art. Purely by way of example, mention may be made of particles having a gradient structure, a core-shell structure, a salami structure, a multinuclear structure, a multilayer structure and raspberry morphology.

Furthermore, the spinnable formulation additionally comprises a water-soluble polymer which gives the solution fiber-forming properties.

In principle, all water-soluble polymers known to those skilled in the art, in particular those based on or consisting of polyvinyl alcohol, polyvinyl formamide, polyvinylamine, polycarboxylic acid (polyacrylic acid, polymethacrylic acid), polyacrylamide, polyitaconic acid, poly(2-hydroxyethyl acrylate), poly(N-isopropylacrylamide), polysulfonic acid (poly(2-acrylamido-2-methyl-1-propanesulfonic acid) or PAM PS), polymethacrylamide, polyalkylene oxides, e.g. polyethylene oxides; poly-N-vinylpyrrolidone; hydroxymethylcelluloses; hydroxyethylcelluloses; hydroxypropylcelluloses; carboxymethylcelluloses; maleic acids; poly(ethylenimine), polystyrenesulfonic acids; biopolymers such as alginates; collagens; gelatin; polysaccharide; combinations made up of two or more of the monomer units forming the abovementioned polymers, copolymers made up of two or more of the monomer units forming the abovementioned polymers, graft copolymers made up of two or more of the monomer units forming the abovementioned polymers, star polymers made up of two or more of the monomer units forming the abovementioned polymers, highly branched polymers made up of two or more of the monomer units forming the abovementioned polymers and dendrimers made up of two or more of the monomer units forming the abovementioned polymers, can be added to the colloidal dispersion of the hydrophobic polymer in an aqueous medium.

In a preferred embodiment of the present invention, the water-soluble polymer is selected from among polyvinyl alcohols, polyethylene oxides, polyvinylformamides, polyvinylamines and poly-N-vinylpyrrolidones.

The amount of the water-soluble polymer (template polymer) is, based on the total solids, from 0.1 to 50% by weight, preferably from 0.5 to 15% by weight and particularly preferably 1-10% by weight.

The aqueous dispersion of the hydrophobic polymer can optionally also comprise a surfactant. Suitable surfactants are, for example, nonionic, anionic and cationic surfactants and mixtures of at least one nonionic and at least one anionic surfactant, mixtures of at least one nonionic and at least one cationic surfactant, mixtures of a plurality of nonionic surfactants or a plurality of cationic surfactants or a plurality of anionic surfactants.

The spinnable formulation can comprise the surfactants in an amount of up to 10% by weight. If it comprises a surfactant, the amounts of surfactant present in the solution or dispersion are preferably from 0.01 to 5% by weight.

The sheet-like fiber structures obtained from the aqueous formulation are treated at above the melting point or glass transition temperature of the essentially water-insoluble polymer so as to produce coalescence of the polymer particles within the fibers and thus obtain a stable fiber network.

The solution or dispersion of the hydrophobic polymer can optionally comprise further customary additives, e.g. dyes, biocides, particulate inorganic compounds such as silicon dioxide, aluminum oxide, silicon carbide, titanium dioxide, zinc oxide, calcium carbonate, marble and corundum. It is also possible for organic particulate compounds such as fully polymerized melamine resin particles, polystyrene particles, etc., to be comprised. The average particle diameter of the inorganic compounds is, for example, from 1 nm to 3000 nm. The amount of these additives is, for example, from 0 to 50% by weight, preferably from 0 to 20% by weight, based on the solids in the solution or the dispersion.

In the further process step, the formulation is applied to the electrode by means of electrospinning processes or rotor spinning processes.

The electrostatic spinning of at least one polymer can be carried out in any way known to those skilled in the art. This means that the electrostatic spinning comprises electrostatic spinning of an aqueous polymer solution and of an aqueous dispersion of an essentially water-insoluble polymer.

The starting material is preferably introduced as solution or fine dispersion into a field having gravitational forces. For this purpose, the fiber raw material is introduced into a container and the container is rotated, resulting in the fluidized fiber raw material being discharged from the container in the form of fibers by centripetal or centrifugal forces. The fibers can subsequently be transported away by a stream of gas and laid together to form sheet-like structures.

By means of the abovementioned electrospinning and rotor spinning processes, it is possible to produce nanofibers or mesofibers, which are generally obtained directly in the form of sheet-like textile structures, from solution or from aqueous dispersion.

This means that the sheet-like textile structures are usually obtained directly during the electrospinning process. For this purpose, the polymer threads formed during the electrospinning process can be deposited on, for example, a carrier, e.g. a glass carrier or a polymer film or on a conveyor belt, for example on a polypropylene substrate, with a sheet-like textile structure being formed by mixing and entanglement of the polymer threads. It is, for example, possible to carry out the electrospinning process in such a way that, for example, at least two spinning nozzles are arranged at an angle to one another and the polymer threads leaving the spinning nozzles are mixed and entangled before impinging on the conveyor belt.

Thus, either nanofibers or mesofibers can be produced or sheet-like textile structures can be obtained directly.

Particularly preferred embodiments of spinning are indicated below:

### Variant 1, Electrostatic Spinning:

In this variant, a solution, colloidal dispersion or melt comprising the electrode material or a precursor thereof is introduced into an electric field having a strength of generally from 0.01 to 10 kV/cm, preferably from 1 to 6 kV/cm and particularly preferably from 2 to 4 kV/cm, by expressing it under a low pressure from one or more cannulas. As soon as the electric forces exceed the surface tension of the droplets at the cannula tip(s), mass transport in the form of a jet to the opposite electrode occurs. Any solvent present vaporizes in the interelectrode space and the solid of the formulation is then present in the form of fibers on the counterelectrode. Spinning can be carried out in both vertical directions (from the bottom upward and from the top downward) and in the horizontal direction.

### Variant 2, Rotor Spinning

In this variant, a solution, dispersion or melt comprising the electrode material or a precursor thereof is introduced into a vessel in which a metal roller is continually rotated or the spinning formulation is metered onto the roller by means of a separate device. The roller can be smooth, structured or provided with metal wires. Here, part of the formulation remains continually on the roller surface. The electric field between the roller and the counterelectrode (above the roller) results in liquid jets firstly being formed from the formulation and these then losing solvent present or solidifying from the melt on the way to the counterelectrode. The desired nanofiber nonwoven (sheet-like textile structure) is formed on a substrate (e.g. polypropylene, polyester or cellulose) which passes between the two electrodes. The electric field generally has the strength indicated in variant 1. For example, the electric field in variant 2 particularly preferably has a strength of about 2.1 kV/cm (82 kV at an electrode spacing of 25 cm). Spinning can be carried out in both vertical directions (from the bottom upward and from the top downward) and in the horizontal direction. The substrate with the sheet-like textile structure is deposited on the electrode and optionally heat treated.

The electrodes coated by way of example according to these variants 1 and 2 are preferably treated at temperatures above the melting point or glass transition temperature in order to join the fibers at the crossing points or join the individual polymer particles to one another in the dispersion process.

In the case of a sheet-like fiber structure obtained from an aqueous formulation, it can be advantageous to treat the fibers at above the decomposition temperature of the water-soluble polymer if this is permitted by the stability of the hydrophobic water-insoluble polymer.

The rechargeable electrochemical metal-oxygen cells or the rechargeable metal-oxygen batteries, in particular zinc-air batteries, which can be obtained therefrom and which can be produced by the process of the invention comprise the further constituents indicated below:

### Electrolytes

The electrolyte used for the rechargeable electrochemical metal-oxygen cells which can be produced by the process of the invention is, in a preferred embodiment, liquid. Electrolytes used are, in particular, acids or alkalis.

In another preferred embodiment, the electrolyte can also be used in gel form.

### Electric Connections

Positive electrode and negative metal-comprising electrode are connected by means of electric connections. These electric connections are preferably produced by introducing electrode layers composed of conductive and corrosion-resistant materials, preferably carbon or nickel, in a manner known per se and joining these to the corresponding electrodes. Further suitable compounds are Cu alloys known to those skilled in the art, electrically conductive polymers such as polyaniline, 3,4-polyethylenedioxythiophene-polystyrenesulfonate (PEDOT/PSS) or polyacetylene. In a particularly preferred embodiment, a composite of carbon and polymer is used.

### Containers

The electrodes and electrode-separator assemblies produced according to the invention are installed in a suitable container for use. This container preferably consists of a polymer. It is provided with insulated connections for the electrodes and has at least one opening through which oxygen, in particular in the form of air, can enter for operation of the metal-oxygen cell.

The present invention is illustrated by the following examples, which do not, however, restrict the invention:

### EXAMPLE 1

### I. Production of an Anode Composed of Zinc Powder on a Separator

48 g of zinc powder (Aldrich, 350 micron, 99.995%) and 8.5 g of polyvinylidene difluoride powder (Aldrich, 1 micron) were mixed in a mortar. A homogeneous mixture was formed from the starting materials. The zinc/polymer mixture was subsequently applied to a separator material (Teflon film, pore size 0.45 μm). The Teflon film was for this purpose placed between a metal punch and a pressing template. The zinc/polyvinylidene difluoride powder mixture was then introduced and smoothed. Sticking of the upper punch was prevented by finally placing a polyimide film on top of the powder mixture in the pressing template. Pressing was carried out at 210° C. and a pressure of 55 bar. The pressing time was 15 minutes. During pressing, softening of the polyvinylidene difluoride and thus bonding to the separator occurred. A zinc powder anode on the separator was obtained and this displayed good adhesion properties.

A negative electrode (anode+separator) to be used according to the invention was obtained.

The assembly of anode and separator produced in this way is suitable for producing a metal-air battery together with an appropriate cathode.

### EXAMPLE 2

### II. Production of an Air Electrode on a Separator

### II.1. Production of an Aqueous Formulation (Ink)

The following were mixed in a ball mill (Pulverisette 6 from Fritsch, ball diameter 10 mm): 70.6 g of carbon black, commercially available as Ketjen® Black from Akzo, (BET surface area: 850 m²/g (measured in accordance with ISO 9277), average particle diameter: 10 μm), 14.24 g of catalyst Mo_{1.2}V0.8Fe_{1.6}O_{0.8} from BASF SE,

15.7 g of an aqueous dispersion of polytetrafluoroethylene having a solids content of 60% and 180 ml of water.

The mixture was milled at 300 rpm for a period of 30 minutes. The balls were then separated off. 15.2 g of n-propanol were added to give an ink to be used according to the invention (for cathode production).

II.2 Application of the Ink to be Used According to the Invention from II.1 and Production of an Electrode to be Used According to the Invention

A glass fiber separator of the type 250 μm GF/F from Whatman was used as substrate. The ink to be used according to the invention was subsequently sprayed at 75° C. under reduced pressure onto the substrate by means of a spray gun, with nitrogen being used for spraying. This gave a catalyst loading of 5 mg/cm², calculated for the sum of carbon black, catalyst and binder.

The coated substrate was subsequently treated thermally in an oven, temperature: 320° C. At this temperature, the polytetrafluoroethylene (binder) became soft.

A positive electrode (cathode+separator) to be used according to the invention was obtained. The separator-air electrode assembly produced in this way is suitable, together with an appropriate anode, for producing a metal-air battery.

### EXAMPLE 3

### III. Production of a Separator-Gas Diffusion Electrode Assembly

### III.1 Production of Electrode Materials for a Gas Diffusion Electrode

### III.1a Production of Ink, Batch 1

In a stirred vessel, 2 g of ethoxylated trimethylnonyl alcohol and 66.7 g of water were mixed with the aid of a magnetic stirrer. 2.1 g of discharging catalyst Ag/C—20% of Ag on carbon black were then added while stirring. The mixture was subsequently dispersed by means of ultrasound, using the following procedure: 14 mm US ultrasonic probe, cycle 1, amplitude 45%, 8° C. cooling, magnetic stirrer 75% up to an energy input of 0.025 kWh. 3.4 g of an aqueous dispersion of polytetrafluoroethylene having a solids content of 60% were subsequently added and the mixture was stirred for 15 minutes without further ultrasound. The mixture was filtered through a 190 μm sieve to give an ink which will hereinafter also be referred to as ink 1.

### III.1b Production of an Ink, Batch 2

In a stirred vessel, 2 g of ethoxylated trimethylnonyl alcohol and 20 g of water were mixed with the aid of a magnetic stirrer. 0.4 g of charging catalyst Fe₂(WO₄)₃, BET surface area of 3 m²/g, were then added while stirring. The mixture was subsequently dispersed by means of ultrasound, using the following procedure: 14 mm US ultrasonic probe, cycle 1, amplitude 45%, 8° C. cooling, magnetic stirrer 75% up to an energy input of 0.025 kWh. 1 g of an aqueous dispersion of polytetrafluoroethylene having a solids content of 60% were subsequently added and the mixture was stirred for 15 minutes without further ultrasound. The mixture was filtered through a 190 μm sieve to give an ink which will hereinafter also be referred to as ink 2.

### III.2 Production of a Gas Diffusion Electrode by Application of Ink 1 and Ink 2

A carbon nonwoven H2315 IX11 CX45 from Freudenberg was used as support material (support). Ink 1 was subsequently sprayed at 75° C. under reduced pressure onto the support by means of a spray gun, with nitrogen being used for spraying. An additional loading of 2 mg/cm², calculated for the sum of discharging catalyst and binder, was obtained. The coated support was subsequently calendered by means of a calender, with the calender being set as follows:

Pressing-on pressure of 2 N/mm²

Advance speed of 0.5 m/min

Roller temperature of 100° C.

In the second coating step, the support coated with ink 1 was used. Ink 2 was sprayed at 75° C. under reduced pressure onto the first coating by means of a spray gun, using nitrogen for spraying. An additional loading of 2 mg/cm², calculated for the sum of charging catalyst and binder, was obtained. The coated support was subsequently calendered by means of a calender, with the calender being set as follows:

Pressing-on pressure of 2 N/mm²

Advance speed of 0.5 m/min

Roller temperature of 100° C.

The carbon nonwoven which had been coated twice on one side was subsequently treated thermally in an oven, temperature: 320° C. At this temperature, the polytetrafluoroethylene softened.

A gas diffusion electrode having oxygen reduction and oxygen evolution catalysts in different layers of the electrode was obtained.

III.3 Coating of a Gas Diffusion Electrode with a Separator

The gas diffusion electrode produced in III.2 was coated with polytetrafluoroethylene (separator material) by means of electrostatic spinning.

To obtain 50 g of a formulation of a spinnable separator material, 33.5 g of a 60% strength by weight polytetrafluoroethylene dispersion in water and 16.65 g of a 12% strength by weight aqueous PVA (40-88) solution were mixed to give a spinning formulation having a viscosity of 2.7 Pa s at 25° C., and this was electrospun under the following conditions:

Plant type: spraying-based

Voltage: 60 kV

Electrode spacing: 15 cm

Temperature: 24° C.

Relative atmospheric humidity: 17%

The coated gas diffusion electrode was subsequently treated thermally in an oven, temperature: 320° C.

A separator-gas diffusion electrode assembly to be used according to the invention was obtained.

The separator-gas diffusion electrode assembly produced in this way is suitable, together with an appropriate anode, for producing a metal-air battery.

1. A process for producing a rechargeable electrochemical metal-oxygen cell comprising a positive electrode, a negative electrode comprising metal, and a separator having two sides for separating the positive and negative electrodes, the process comprising coating a side of the separator with an electrode material for forming one of the two electrodes or coating a side of at least one of the two electrodes with a separator material for forming the separator to form a separator-electrode assembly.

2. The process according to claim 1, wherein the positive electrode is a gas diffusion electrode comprising carbon and a catalyst.

3. The process according to claim 1, wherein
the separator is a porous material based on polyolefin, polytetrafluoroethylene or a glass fiber, or
the separator is a membrane based on an ion-conducting material.

4. The process according to claim 1, wherein the separator has a porosity of from 30 to 80%.

5. The process according to claim 1, wherein the material for forming the negative electrode is the electrode material for coating one side of the separator.

6. The process according to claim 1, wherein the electrode material for forming the positive electrode is the electrode material for coating one side of the separator.

7. The process according to claim 1, comprising:
first coating the separator on one side with the material for forming the positive electrode; and
subsequently coating the separator on the other side with the material for forming the negative electrode, or
the process comprising:
first coating the separator on one side with the material for forming the negative electrode; and
subsequently coating the separator on the other side with the material for forming the positive electrode.

8. The process according to claim 1, wherein the material for forming the negative electrode comprises zinc, aluminum, magnesium or lithium as the metal.

9. The process according to claim 1, wherein the material for forming the negative electrode is present in a form of a paste comprising zinc, aluminum, magnesium or lithium in a form of a powder together with a binder.

10. The process according to claim 1, comprising:
applying the separator to a carrier film;
applying an electrode material in a form of a paste to a side of the separator facing away from the carrier film;
optionally coating, conditioning, or both, by drying;
removing the carrier film;
applying a further electrode material in a form of a paste for forming a second counterelectrode or joining to a separately produced counterelectrode; and
placing a separator-electrode assembly obtained, optionally together with further elements, in a container which is optionally filled with electrolyte or can be filled with electrolyte.

11. The process according to claim 1, wherein the electrode material is applied in a form of a paste by means of screen printing, spraying or doctor blade coating.

12. The process according to claim 1, wherein the separator material is a polymer dissolved in a solvent or a polymerizable material.

13. The process according to claim 1, further comprising applying a polymer dissolved in a solvent or a polymerizable material to an electrode to form the separator.

14. The process according to claim 1, comprising applying a polymer dissolved in a solvent or a polymerizable material as the separator material to the negative electrode, to obtain the negative electrode being enclosed on all sides by the separator.

15. The process according to claim 12, wherein the separator material is an ion-conducting organic material.

16. The process according to claim 1, further comprising spinning a spinnable formulation of a polymer dissolved in a solvent to form the separator.
